(19) United States
(12) Patent Application Publication
(10) Pub. No.: US 2025/0374959 A1
(43) Pub. Date: Dec. 11, 2025

(54) INTELLIGENT ASH COLLECTION DEVICE

(71) Applicant: Zaidong Wen, Xingning (CN)

(72) Inventor: Zaidong Wen, Xingning (CN)

(21) Appl. No.: 19/310,693

(22) Filed: Aug. 26, 2025

(51) Int. Cl. A24F 19/00; A24F 19/10; B01D 46/00; B01D 46/10

(52) U.S. Cl. CPC A24F 19/0042; A24F 19/0085; A24F 19/10; B01D 46/0005; B01D 46/0045; B01D 46/0047; B01D 46/10; B01D 2273/30; B01D 2279/35

(57) ABSTRACT

The present disclosure belongs to the technical field of intelligent storage, and in particular to an intelligent ash collection device, comprising a housing provided with an open cavity; an automatic flip cover rotatably connected to an opening edge of the open cavity and capable of controlling opening and closing of the open cavity; an igniter disposed at an end portion of the automatic flip cover facing the open cavity; a rotating base disposed at a bottom of the housing and configured to drive the housing to rotate and adjust in a horizontal direction; a lifting mechanism disposed on a bottom wall of the open cavity; an ash bin disposed at an output end of the lifting mechanism and configured to collect ash; and a filter mechanism disposed between the ash bin and the output end of the lifting mechanism and configured to collect, filter and purify smoke in the ash bin.

### The present disclosure belongs to the technical field of intelligent storage, and in particular to an intelligent ash collection device.

### BACKGROUND

In the prior art, the design of smart ashtrays primarily focuses on improving convenience and basic hygiene functions. Common enhancements include automatic lid opening and closing through infrared or gravity sensors to reduce manual operation and prevent ash dispersion. Some products incorporate small ignition devices, yet these still require user activation or proximity for operation, failing to achieve a fully automated ignition process. Furthermore, ash containment typically relies on fixed-depth storage cavities, necessitating regular manual cleaning and disposal. Regarding smoke and harmful gases generated during smoking, existing products generally lack effective mechanisms for active collection, treatment, and filtration-purification, predominantly depending on passive diffusion or simple ventilation holes, which are insufficient to significantly improve ambient air quality.

However, existing smart ashtrays still exhibit significant deficiencies in terms of functional integration and automation. They are generally incapable of achieving fully intelligent operation without user intervention, such as automatically completing the entire process of lid opening, ignition, ash collection, and smoke treatment upon detecting a cigarette. Specifically, the automation of lid opening and closing remains limited, often failing to precisely respond to cigarette placement or retrieval actions; the ignition process still requires manual assistance, lacking a truly hand-free automatic lighting experience; the ash storage compartment predominantly features a fixed structure without the ability to automatically adjust its height based on ash volume or usage status, thereby unable to optimize space or provide cleaning reminders; most critically, there is a lack of an active capture and efficient purification system for continuously generated smoke during smoking in the prior art, resulting in ineffective removal of harmful particulate matter and odors, which fundamentally fails to meet the requirements of indoor air cleanliness. These limitations hinder the enhancement of user experience and the comprehensive functionality of the product.

### SUMMARY OF THE APPLICATION

The objective of the present disclosure is to provide an intelligent ash collection device, which aims to solve the technical problems that the ash collection devices in the prior art have a single function and lack comprehensiveness.

To achieve the above objective, the embodiments of the present disclosure provide an intelligent ash collection device, comprising: a housing provided with an open cavity; an automatic flip cover rotatably connected to an opening edge of the open cavity and capable of controlling opening and closing of the open cavity; an igniter disposed at an end portion of the automatic flip cover facing the open cavity; a rotating base disposed at a bottom of the housing and configured to drive the housing to rotate and adjust in a horizontal direction; a lifting mechanism disposed on a bottom wall of the open cavity; an ash bin disposed at an output end of the lifting mechanism and configured to collect ash; and a filter mechanism disposed between the ash bin and the output end of the lifting mechanism and configured to collect, filter and purify smoke in the ash bin.

In some embodiments, the filter mechanism includes a connecting box body, a filter unit and a drive unit, the connecting box body is disposed at an end portion of the ash bin, and the other end of the connecting box body is fixedly connected to a drive end of the lifting mechanism, the filter unit is disposed in the connecting box body, and the drive unit is disposed in the connecting box body, and air holes are disposed at opposite end portions of the connecting box body and the housing, so that the smoke in the ash bin is capable of entering the connecting box body through the air holes and passing through the filter unit and the drive unit in sequence.

In some embodiments, a mounting base is disposed in a middle position of the connecting box body, a mounting cavity is disposed in the mounting base, the filter unit is disposed on a bottom wall of the mounting cavity, the drive unit is disposed in the mounting cavity, the drive unit is a drive fan, an input end of the drive fan faces the filter unit, the air holes face the mounting base, and the smoke in the ash bin enters the mounting cavity through the air holes and passes through the filter unit and the drive unit in sequence.

In some embodiments, the mounting cavity is provided with an opening away from the air holes, and an output end of the drive unit is aligned with the opening of the mounting cavity. After the smoke in the ash bin enters the mounting cavity from the air holes, it is filtered by the filter unit and driven by the drive unit, and leaves the connecting box body from the opening of the mounting cavity.

In some embodiments, the connecting box body is arranged in an annular structure, the mounting base is formed in an inner circle of the connecting box body, the mounting base is arranged in an annular structure, the mounting cavity is formed through an inner circle of the mounting base, the filter unit includes a connecting base and a filter element, the connecting base laps an opening position of the mounting cavity close to the ash bin, the filter element is disposed on the mounting base, the air holes are formed on the connecting base, and the drive unit is arranged at an end portion of the mounting cavity away from the ash bin and located on the other side of the connecting base.

In some embodiments, a recess of the connecting base away from the ash bin is provided with a limiting groove for accommodating the filter element, and the air holes are disposed on a bottom wall of the limiting groove.

In some embodiments, the filter element is made of non-woven fabric or sponge.

In some embodiments, a gap is provided between the connecting box body and the bottom wall of the open cavity, and a filtered gas output by the drive unit moves from the opening of the mounting cavity to the outside of the connecting box body and to the bottom wall position of the open cavity.

In some embodiments, the lifting mechanism includes a second mounting base, a second drive unit and swing arms, two sets of swing arms are provided, the second mounting base is fixedly disposed on a bottom wall of the open cavity, the second drive unit is disposed on the second mounting base, the two sets of swing arms are rotatably connected to the second mounting base, an output end of a second drive source is rotatably connected to the two sets of swing arms, and end portions of the two sets of swing arms away from the second drive unit abut against a bottom of the filter mechanism.

In some embodiments, the second drive unit is a drive motor, an output end of the second drive unit is provided with a drive gear, end portions of the swing arms close to the second drive unit are provided with second tooth portions, the second tooth portions are meshed with the drive gear, and rotation directions of the two sets of swing arms are always opposite.

In some embodiments, rollers are rotatably connected to the end portions of the swing arms away from the second drive unit, and the rollers abut against the bottom of the filter mechanism in a rolling manner.

In some embodiments, the automatic flip cover includes a third drive unit, a rotating cover body and a third mounting base, the third mounting base is disposed at the opening edge of the open cavity, the third drive unit is disposed on the third mounting base, the rotating cover body is rotatably connected to the third mounting base, and the third drive unit is drivingly connected to an end portion of the rotating cover body.

In some embodiments, the third drive unit is a drive motor, an output end of the third drive unit is provided with a flip cover gear, the third mounting base is provided with a transmission gear, and an end portion of the rotating cover body is provided with third tooth portions meshed with the transmission gear.

In some embodiments, an identification mechanism is provided on the opening edge of the open cavity away from a rotating portion of the automatic flip cover, the identification mechanism is configured to monitor approaching of an object, and a control center is disposed in the housing and electrically connected to the automatic flip cover, the igniter, the rotating base and the identification mechanism.

The one or more technical solutions of the intelligent ash collection device provided by the embodiments of the present disclosure have at least one of the following technical effects: by providing the housing with the open cavity, the lifting mechanism located on the bottom wall of the cavity, the ash bin driven to rise and fall by the lifting mechanism, and the filter mechanism located between the ash bin and the output end of the lifting mechanism, the shortcomings of the prior art are effectively solved, and the ash bin is automatically lifted and lowered according to the usage requirements or ash accumulation, thereby optimizing space utilization and facilitating cleaning. Meanwhile, the filter mechanism can actively collect the smoke generated in the ash bin and filter and purify it, significantly reducing the emission of harmful particulate matter and odor to the surrounding environment, thereby improving the convenience of use and the degree of automation while effectively improving the local air quality, providing users with a cleaner and smarter smoking experience.

### BRIEF DESCRIPTION OF THE DRAWINGS

To illustrate the technical solutions in the embodiments of the present disclosure more clearly, the following will briefly introduce the accompanying figures used in the description of the embodiments or the prior art. Obviously, the accompanying figures described below are only some embodiments of the present disclosure. Those having ordinary skills in the art can obtain other accompanying figures based on these figures without creative work.

FIG. 1 is a schematic structural diagram of an intelligent ash collection device according to the embodiments of the present disclosure.

FIG. 2 is a cross-sectional view of an intelligent ash collection device according to the embodiments of the present disclosure.

FIG. 3 is a cross-sectional view of a lifting mechanism, a filter mechanism and an ash bin according to the embodiments of the present disclosure.

FIG. 4 is a schematic structural diagram of an automatic flip cover according to the embodiments of the present disclosure.

FIG. 5 is a schematic structural diagram of a lifting mechanism according to the embodiments of the present disclosure.

FIG. 6 is a cross-sectional view of a lifting mechanism according to the embodiments of the present disclosure.

Reference signs in the figures:

| | | |
|---|---|---|
| 100-housing | 200-lifting mechanism | 300-ash bin |
| 400-open cavity | 500-filter mechanism | 510-connecting box body |
| 520-filter unit | 530-drive unit | 540-mounting base |
| 541- mounting cavity | 542-air hole | 521-connecting |
| base | | |
| 522-filter element | 523-limiting groove | 600-automatic |
| flip cover | | |
| 700-igniter | 800-rotating base | 900-identification |
| mechanism | | |
| 1000-control center | | |

### DETAILED DESCRIPTION

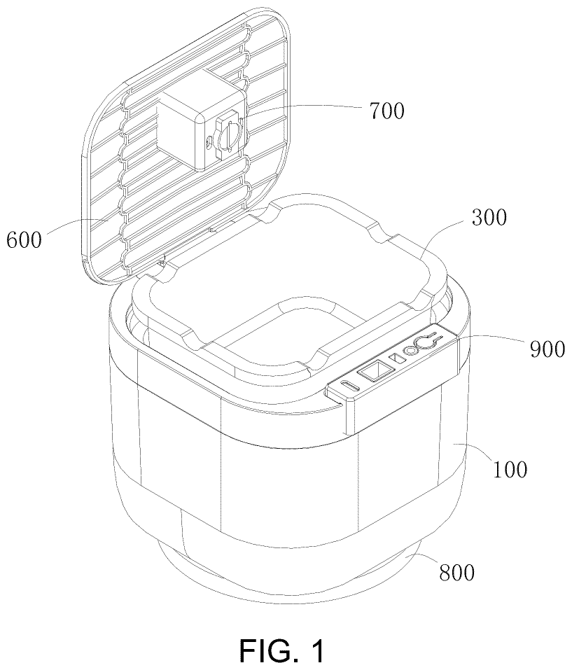

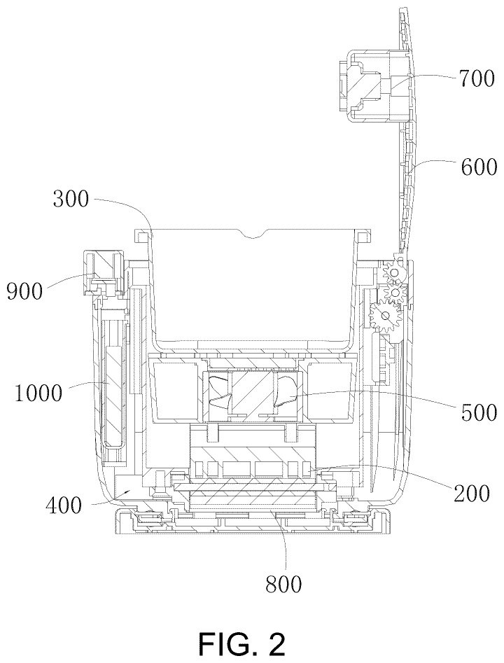

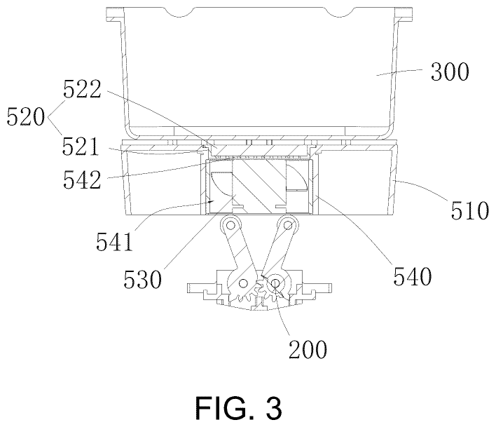

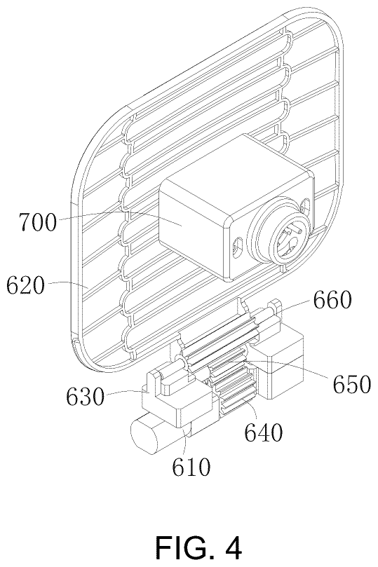

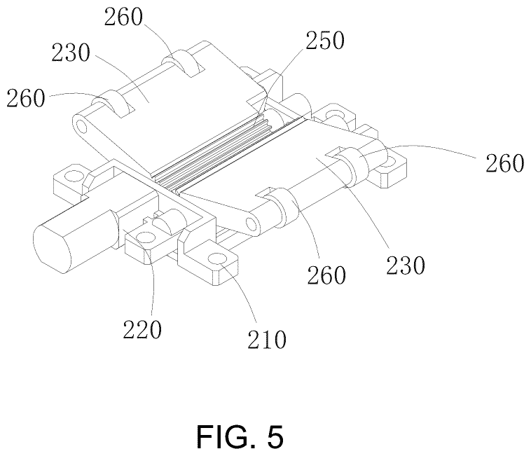

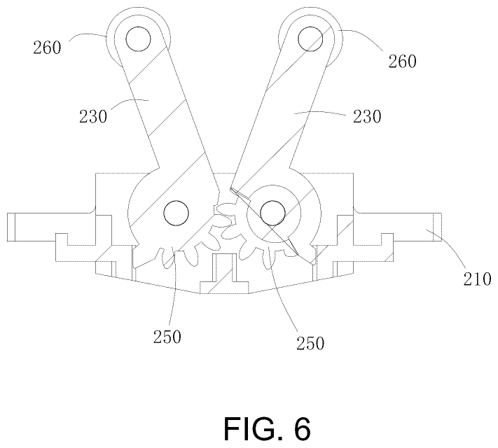

The embodiments of the present disclosure are described in detail below. Examples of the embodiments are illustrated in the accompanying drawings, wherein the same or similar reference numerals throughout represent the same or similar elements or elements having the same or similar functions. The embodiments described below with reference to FIGS. 1-6 are exemplary and are intended to explain the embodiments of the present disclosure and are not to be construed as limiting the present disclosure.

In the description of the embodiments of the present disclosure, it should be understood that the terms “length”, “width”, “up”, “down”, “front”, “back”, “left”, “right”, “vertical”, “horizontal”, “top”, “bottom”, “inside”, “outside”, etc., indicating the orientation or position relationship, are based on the orientation or position relationship shown in the accompanying drawings, and are only for the convenience of describing the embodiments of the present disclosure and simplifying the description, rather than indicating or implying that the device or element referred to must have a specific orientation, be constructed and operated in a specific orientation, and therefore cannot be understood as limiting the present disclosure.

Furthermore, the terms “first” and “second” are used for descriptive purposes only and should not be understood to indicate or imply relative importance or implicitly specify the number of the technical features indicated. Thus, a feature defined as “first” or “second” may explicitly or implicitly include one or more of the features. In the description of the embodiments of the present disclosure, “multiple” means two or more, unless otherwise specifically defined.

In the embodiments of the present disclosure, unless otherwise expressly specified or limited, the terms “mounted”, “connected”, “connection”, “fixed”, etc. should be understood in a broad sense. For example, they refer to fixed connection, detachable connection, or integration; mechanical connection or electrical connection; direct connection or indirect connection through an intermediate medium; internal communication between two components or interaction between two components. Those skilled in the art will understand the specific meanings of the above terms in the embodiments of the present disclosure based on specific circumstances.

In one embodiment of the present disclosure, as shown in FIGS. 1-6, an intelligent ash collection device is provided, including a housing 100, a lifting mechanism 200, a filter mechanism 500 and an ash bin 300. The housing 100 is provided with an open cavity 400; the lifting mechanism 200 is disposed on a bottom wall of the open cavity 400; the ash bin 300 is disposed at an output end of the lifting mechanism 200 and configured to collect ash; the filter mechanism 500 is disposed between the ash bin 300 and the output end of the lifting mechanism 200 and configured to collect, filter and purify smoke in the ash bin 300.

By providing the housing 100 with the open cavity 400, the lifting mechanism 200 located on the bottom wall of the cavity, the ash bin 300 driven to rise and fall by the lifting mechanism 200, and the filter mechanism 500 located between the ash bin 300 and the output end of the lifting mechanism 200, the shortcomings of the prior art are effectively solved, and the ash bin 300 is automatically lifted and lowered according to the usage requirements or ash accumulation, thereby optimizing space utilization and facilitating cleaning. Meanwhile, the filter mechanism 500 can actively collect the smoke generated in the ash bin 300 and filter and purify it, significantly reducing the emission of harmful particulate matter and odor to the surrounding environment, thereby improving the convenience of use and the degree of automation while effectively improving the local air quality, providing users with a cleaner and smarter smoking experience.

As shown in FIGS. 1-6, in another embodiment of the present disclosure, the filter mechanism 500 includes a connecting box body 510, a filter unit 520 and a drive unit 530. The connecting box body 510 is disposed at an end portion of the ash bin 300, and the other end of the connecting box body 510 is fixedly connected to a drive end of the lifting mechanism 200. The filter unit 520 is disposed in the connecting box body 510, and the drive unit 530 is disposed in the connecting box body 510, and air holes 542 are disposed at opposite end portions of the connecting box body 510 and the housing 100, so that the smoke in the ash bin 300 is capable of entering the connecting box body 510 through the air holes 542 and passing through the filter unit 520 and the drive unit 530 in sequence. This structure enables the smoke in the ash bin 300 to be actively drawn into the connecting box body 510, where it is forced to flow through the filer unit 520 for purification treatment. The drive unit 530 provides power to guide the direction of the airflow, effectively enhancing the efficiency and reliability of smoke gas collection and purification.

As shown in FIGS. 1-6, in another embodiment of the present disclosure, a mounting base 540 is disposed in a middle position of the connecting box body 510, a mounting cavity 541 is disposed in the mounting base 540, the filter unit 520 is disposed on a bottom wall of the mounting cavity 541, and the drive unit 530 is disposed in the mounting cavity 541. The drive unit 530 is a drive fan. An input end of the drive fan faces the filter unit 520, the air holes 542 face the mounting base 540, and the smoke in the ash bin 300 enters the mounting cavity 541 through the air holes 542 and passes through the filter unit 520 and the drive unit 530 in sequence. When the drive fan is running, a negative pressure is generated in the mounting cavity 541, and the smoke in the ash bin 300 is drawn into the mounting cavity 541 through the air holes 542. The smoke first flows through and passes through the filter unit 520, where the particulate matter and odor are adsorbed and filtered, and then is sucked in and pushed by the drive fan, thereby realizing the purification process of forcing the smoke to pass through the filter element 522, ensuring the filtering effect.

As shown in FIGS. 1-6, in another embodiment of the present disclosure, the mounting cavity 541 is provided with an opening away from the air holes 542. An output end of the drive unit 530 is aligned with the opening of the mounting cavity 541. After the smoke in the ash bin 300 enters the mounting cavity 541 through the air holes 542, it is filtered by the filter unit 520 and driven by the drive unit 530 before leaving the connecting box body through the opening of the mounting cavity 541. After being purified by the filter unit 520, clean air, driven by the drive fan, is discharged from the connecting box body 510 through the opening of the mounting cavity 541 away from the air holes 542, forming a directional airflow path, which prevents the purified air from backflowing or mixing with untreated smoke, thereby ensuring that the purified air is effectively directed and discharged to an intended region.

As shown in FIGS. 1-6, in another embodiment of the present disclosure, the connecting box body 510 is arranged in an annular structure, the mounting base 540 is formed in an inner circle of the connecting box body 510, the mounting base 540 is arranged in an annular structure, the mounting cavity 541 is formed through an inner circle of the mounting base 540, the filter unit 520 includes a connecting base 521 and a filter element 522, the connecting base 521 laps an opening position of the mounting cavity 541 close to the ash bin 300, the filter element 522 is disposed on the mounting base 540, the air holes 542 are formed on the connecting base 521, and the drive unit 530 is arranged at an end portion of the mounting cavity 541 away from the ash bin 300 and located on the other side of the connecting base 521. The annular connecting box body 510 and the mounting base 540 have a compact structure and make full use of the space. The smoke enters the mounting cavity 541 through the air holes 542 on the connecting base 521, first contacts and flows through the filter element 522 located on the mounting base 540 for filtration, and drives the fan located downstream of the filter element 522 to draw the smoke through the filter element 522 and push the clean air out. The annular design is conducive to the uniform distribution of airflow and the integrated layout of components.

As shown in FIGS. 1-6, in another embodiment of the present disclosure, a recess of the connecting base 521 away from the ash bin 300 is provided with a limiting groove 523 for accommodating the filter element 522, and the air holes 542 are disposed on a bottom wall of the limiting groove 523. The structure of the limiting groove 523 facilitates the positioning, mounting, and replacement of the filter element 522, ensuring that the filter element 522 is securely placed within the connecting base 521. The air holes 542 are located on the bottom wall of the limiting groove 523, allowing the incoming smoke to be evenly dispersed and pass through the entire filter surface of the filter element 522, thereby improving the utilization rate and filtering effect of the filter element 522.

As shown in FIGS. 1-6, in another embodiment of the present disclosure, the filter element 522 is made of non-woven fabric or sponge. Using the non-woven fabric or sponge as the material of the filter element 522 is low-cost and readily available, effectively adsorbing tar particles and some odorous substances in the smoke. It also allows users to replace it regularly based on usage to maintain the filtering effect.

As shown in FIGS. 1-6, in another embodiment of the present disclosure, a gap is provided between the connecting box body 510 and the bottom wall of the open cavity 400, and a filtered gas output by the drive unit 530 moves from the opening of the mounting cavity 541 to the outside of the connecting box body and to the bottom wall position of the open cavity 400. The purified gas discharged from the opening of the mounting cavity 541 flows downward through the gap between the connecting box body 510 and the bottom wall of the housing 100 to the bottom region of the open cavity 400. This design helps direct relatively clean air below the device or to a specific region, preventing the purified gas from immediately mixing with untreated smoke above the ashtray, thereby promoting renewal of local air to a certain extent.

As shown in FIGS. 1-6, in another embodiment of the present disclosure, the intelligent ash collection device further includes an automatic flip cover 600, an igniter 700, and a rotating base 800. The automatic flip cover 600 is disposed at an opening edge of the open cavity 400, the igniter 700 is disposed at an end portion of the automatic flip cover 600 facing the open cavity 400, and the housing 100 is disposed at a rotating end of the rotating base 800. The automatic flip cover 600 automatically opens when the user approaches or needs to, making it convenient to take cigarettes in and out. The igniter 700 is integrated into the flip cover to facilitate automatic ignition after a cigarette is placed in. The rotating base 800 supports the rotation of the entire housing 100, making it convenient for users to use the device from different angles, thereby significantly improving the convenience of use and the intelligent experience.

As shown in FIGS. 1-6, in another embodiment of the present disclosure, the lifting mechanism 200 includes a second mounting base 210, a second drive unit 220 and swing arms 230. Two sets of swing arms 230 are provided. The second mounting base 210 is fixedly disposed on a bottom wall of the open cavity. The second drive unit 220 is disposed on the second mounting base 210. The two sets of swing arms 230 are rotatably connected to the second mounting base 210. An output end of a second drive source is rotatably connected to the two sets of swing arms 230. End portions of the two sets of swing arms 230 away from the second drive unit 220 abut against a bottom of the filter mechanism. When the second drive unit 220 is activated, its output end drives the two sets of swing arms 230 to rotate synchronously on the second mounting base 210. Since the end portions of the two sets of swing arms 230 abut and support the filter mechanism (and thus the ash bin), a change in a rotation angle of the swing arms 230 is directly converted into a vertical lifting and lowering motion of the filter mechanism. This simple and reliable structure can stably raise or lower the ash bin.

As shown in FIGS. 1-6, in another embodiment of the present disclosure, the second drive unit 220 is a drive motor. An output end of the second drive unit 220 is provided with a drive gear (not shown in the figures), end portions of the swing arms 230 close to the second drive unit 220 are provided with second tooth portions 250, the second tooth portions 250 are meshed with the drive gear, and rotation directions of the two sets of swing arms 230 are always opposite. The drive motor drives the drive gear to rotate, and the drive gear are simultaneously meshed with the tooth portions at the end portions of the two sets of swing arms 230. Due to the characteristics of gear meshing, when the drive gear rotates, the tooth portions of the two meshing swing arms 230 drive the two sets of swing arms 230 to rotate at the same angular velocity but in opposite directions, ensuring that the ash bin is subjected to balanced force during the lifting process, and the movement is smooth and highly synchronized. In other embodiments, in order to save mounting steps and optimize the structure, the output end of the second drive unit can be directly connected to one of the second tooth portions 250.

As shown in FIGS. 1-6, in another embodiment of the present disclosure, rollers 260 are rotatably connected to the end portions of the swing arms 230 away from the second drive unit 220, and the rollers 260 abut against the bottom of the filter mechanism in a rolling manner. The rollers 260 are disposed between the end portions of the swing arms 230 and the bottom of the filter mechanism. When the swing arms 230 rotate to raise or lower the filter mechanism, the rollers 260 roll against the bottom of the filter mechanism, converting sliding friction into rolling friction, which significantly reduces motion resistance, energy loss, and component wear, resulting in a smoother and quieter lifting motion and extending the service life of the mechanism.

As shown in FIGS. 1-6, in another embodiment of the present disclosure, the automatic flip cover 600 includes a third drive unit 610, a rotating cover body 620 and a third mounting base 630. The third mounting base 630 is disposed at the opening edge of the open cavity. The third drive unit 610 is disposed on the third mounting base 630. The rotating cover body 620 is rotatably connected to the third mounting base 630. The third drive unit 610 is drivingly connected to an end portion of the rotating cover body 620. After the third drive unit 610 is activated, its output end directly or indirectly drives the rotating cover body 620 to rotate about its rotation axis on the third mounting base 630, which realizes automatic opening or closing of the cover body, and replaces the traditional mode of manual opening and closing, thereby improving the convenience and intelligence of use.

As shown in FIGS. 1-6, in another embodiment of the present disclosure, the third drive unit 610 is a drive motor. An output end of the third drive unit 610 is provided with a flip cover gear 640. The third mounting base 630 is provided with a transmission gear 650. An end portion of the rotating cover body 620 is provided with third tooth portions 660 meshed with the transmission gear 650. The drive motor drives the flip cover gear 640 to rotate, and the flip cover gear 640 drives the meshing transmission gear 650. The transmission gear 650 then drives the third tooth portions 660 at the end portion of the rotating cover body 620, forming a gear transmission chain. The rotational motion of the motor is accurately and reliably converted into the rotational opening and closing motion of the cover body, thereby achieving high transmission efficiency, precise control, and precise opening and closing.

As shown in FIGS. 1-6, in another embodiment of the present disclosure, an identification mechanism 900 is provided on the opening edge of the open cavity 400 away from a rotating portion of the automatic flip cover 600. The identification mechanism 900 is configured to monitor approaching of an object. A control center 1000 (e.g., a digital control integrated circuit) is disposed in the housing 100 and electrically connected to the automatic flip cover 600, the igniter 700, the rotating base 800 and the identification mechanism 900. When the identification mechanism 900 (e.g., an infrared sensor) detects the approach of a user's hand or cigarette, it transmits a signal to the control center 1000. The control center 1000 then coordinates the opening of the automatic flip cover 600 and the operation of the igniter 700, and can respond to an adjustment command from the rotating base 800, which achieves an automated response chain from perception to action (opening the cover, and igniting), and eliminates the need for manual operation by the user, thereby significantly improving user convenience and intelligence.

The above description is only a preferred embodiment of the present disclosure and is not intended to limit the present disclosure. Any modifications, equivalent substitutions and improvements made within the spirit and principle of the present disclosure should be included in the scope of protection of the present disclosure.

1. An intelligent ash collection device, comprising:
a housing provided with an open cavity;
an automatic flip cover rotatably connected to an opening edge of the open cavity and capable of controlling opening and closing of the open cavity;
an igniter disposed at an end portion of the automatic flip cover facing the open cavity;
a rotating base disposed at a bottom of the housing and configured to drive the housing to rotate and adjust in a horizontal direction;
a lifting mechanism disposed on a bottom wall of the open cavity;
an ash bin disposed at an output end of the lifting mechanism and configured to collect ash; and
a filter mechanism disposed between the ash bin and the output end of the lifting mechanism and configured to collect, filter and purify smoke in the ash bin.

2. The intelligent ash collection device according to claim 1, wherein the filter mechanism includes a connecting box body, a filter unit and a drive unit, the connecting box body is disposed at an end portion of the ash bin, and the other end of the connecting box body is fixedly connected to a drive end of the lifting mechanism, the filter unit is disposed in the connecting box body, and the drive unit is disposed in the connecting box body, and air holes are disposed at opposite end portions of the connecting box body and the housing, so that the smoke in the ash bin is capable of entering the connecting box body through the air holes and passing through the filter unit and the drive unit in sequence.

3. The intelligent ash collection device according to claim 2, wherein a mounting base is disposed in a middle position of the connecting box body, a mounting cavity is disposed in the mounting base, the filter unit is disposed on a bottom wall of the mounting cavity, the drive unit is disposed in the mounting cavity, the drive unit is a drive fan, an input end of the drive fan faces the filter unit, the air holes face the mounting base, and the smoke in the ash bin enters the mounting cavity through the air holes and passes through the filter unit and the drive unit in sequence.

4. The intelligent ash collection device according to claim 3, wherein the connecting box body is arranged in an annular structure, the mounting base is formed in an inner circle of the connecting box body, the mounting base is arranged in an annular structure, the mounting cavity is formed through an inner circle of the mounting base, the filter unit includes a connecting base and a filter element, the connecting base laps an opening position of the mounting cavity close to the ash bin, the filter element is disposed on the mounting base, the air holes are formed on the connecting base, and the drive unit is arranged at an end portion of the mounting cavity away from the ash bin and located on the other side of the connecting base.

5. The intelligent ash collection device according to claim 1, wherein the lifting mechanism includes a second mounting base, a second drive unit and swing arms, two sets of swing arms are provided, the second mounting base is fixedly disposed on a bottom wall of the open cavity, the second drive unit is disposed on the second mounting base, the two sets of swing arms are rotatably connected to the second mounting base, an output end of a second drive source is rotatably connected to the two sets of swing arms, and end portions of the two sets of swing arms away from the second drive unit abut against a bottom of the filter mechanism.

6. The intelligent ash collection device according to claim 5, wherein the second drive unit is a drive motor, an output end of the second drive unit is provided with a drive gear, end portions of the swing arms close to the second drive unit are provided with second tooth portions, the second tooth portions are meshed with the drive gear, and rotation directions of the two sets of swing arms are always opposite.

7. The intelligent ash collection device according to claim 5, wherein rollers are rotatably connected to the end portions of the swing arms away from the second drive unit, and the rollers abut against the bottom of the filter mechanism in a rolling manner.

8. The intelligent ash collection device according to claim 1, wherein the automatic flip cover includes a third drive unit, a rotating cover body and a third mounting base, the third mounting base is disposed at the opening edge of the open cavity, the third drive unit is disposed on the third mounting base, the rotating cover body is rotatably connected to the third mounting base, and the third drive unit is drivingly connected to an end portion of the rotating cover body.

9. The intelligent ash collection device according to claim 8, wherein the third drive unit is a drive motor, an output end of the third drive unit is provided with a flip cover gear, the third mounting base is provided with a transmission gear, and an end portion of the rotating cover body is provided with third tooth portions meshed with the transmission gear.

10. The intelligent ash collection device according to claim 1, wherein an identification mechanism is provided on the opening edge of the open cavity away from a rotating portion of the automatic flip cover, the identification mechanism is configured to monitor approaching of an object, and a control center is disposed in the housing and electrically connected to the automatic flip cover, the igniter, the rotating base and the identification mechanism.
